(19) United States
(12) Patent Application Publication
(10) Pub. No.: US 2007/0190422 A1
(43) Pub. Date: Aug. 16, 2007

(54) Carbon nanotube lithium metal powder battery

(75) Inventor: Robert Scott Morris, Fairhaven, MA (US)

Correspondence Address: MYERS BIGEL SIBLEY & SAJOVEC, PO BOX 37428, RALEIGH, NC, 27627, US

(73) Assignee: FMC Corporation

(21) Appl. No.: 11/354,738

(22) Filed: Feb. 15, 2006

(51) Int. Cl. H01M 4/58

(52) U.S. Cl. 429/231.4; 429/231.8

(57) ABSTRACT

Disclosed herein is a high-energy lithium battery system. This system comprises carbon nanotubes and/or other nanotubular materials for both the anode and cathode. The anode is lithiated using a lithium metal powder.

### STATEMENT REGARDING FEDERALLY SPONSORED RESEARCH OR DEVELOPMENT

This invention was made partially with U.S. Government support from the Office of Naval Research under contract number N0014-03-M0092. The U.S. Government may have certain rights in the invention.

### FIELD OF THE INVENTION

This invention pertains to energy storage devices. In particular, this invention relates to lithium-ion batteries having two active electrodes composed of carbon nanotube (CNT) material, wherein lithium metal powder is dispersed in the CNT material of the anode.

### BACKGROUND OF THE INVENTION

Future portable power requirements for consumer and military applications will demand greater specific energy and power from lithium battery technology. It is expected that in order to meet future power requirements, lithium batteries will need to exhibit sustained specific energies of greater than 400 Wh/kg and have pulse power capability of greater than 2 kW/kg at 100 Wh/kg. In addition, these systems will need to operate effectively over a wide temperature range (−20 to 90° C.) and be capable of rapid recharge. These requirements cannot be met by conventional batteries or through extrapolation of the capabilities of conventional systems. As is well known, the conventional Li-ion electrode materials are subject to physical chemical constraints, which limit their lithium storage capability.

Conventional commercial lithium-ion battery technology relies on lithiated metal oxides for the positive electrode (cathode) and carbon (of various forms) as the negative electrode (anode). A Li-ion cell begins life with all of the lithium in the cathode and upon charging, a percentage of this lithium is moved over to the anode and intercalated within the carbon anode. When the charging process is finished, the cell has an open circuit voltage of approximately 4.2V. Approximately 1.15V of this cell voltage is due to the positive potential of the metal oxide electrode. The diverse chemistry of these two materials ensures a high open circuit potential. It is conceivable, however, to use materials with similar chemistries to affect a similar result. In 1980, the “rocking chair concept”, i.e., using two insertion compounds based on metallic oxides or sulfides, was proposed by Lazzari and Scrosati (M. Lazzari and B. Scrosati, J. Electrochem. Soc., Brief Communication, March 1980, the entire teaching of which is incorporated herein by reference). A LiₓWO₂/Li_{y}TiS₂ cell was described, working at an average voltage of 1.8 V. While this system could solve the metallic lithium anode problems, it was unable to provide the practical energy density required to make it a viable alternative to existing rechargeable systems. Following this preliminary report, workers moved away from using two metal oxide electrodes, having found that certain types of carbon could reversibly intercalate lithium. Most graphitic carbons offer a stoichiometry of LiC₆ (375 mAh/g) whereas disordered carbons are generally LiₓC₆ (x>1) (400 mAh/g). In comparison to lithiated carbon, lithium metal anodes have a theoretical capacity of >3000 mAh/g and a practical capacity of 965 mAh/g (Linden, D. and Reddy, T. B., Handbook of Batteries, 3^{rd} ed. p 34.8, McGraw-Hill, NY, 2001, the entire teaching of which is incorporated herein by reference).

Carbon nanotubes have attracted attention as potential electrode materials. Carbon nanotubes often exist as closed concentric multi-layered shells or multi-walled nanotubes (MWNT). Nanotubes can also be formed as single-walled nanotubes (SWNT). The SWNT form bundles, these bundles having a closely packed 2-D triangular lattice structure. Both MWNT and SWNT have been produced, and the specific capacity of these materials has been evaluated by vapor-transport reactions. See, for example, O. Zhou et al., Defects in Carbon Nanotubes, Science: 263, pgs. 1744-47, 1994; R. S. Lee et al., Conductivity Enhancement in Single-Walled Nanotube Bundles Doped with K and Br, Nature: 388, pgs. 257-59, 1997; A. M. Rao et al., Raman Scattering Study of Charge Transfer in Doped Carbon Nanotube Bundles, Nature: 388, 257-59, 1997; and C. Bower et al., Synthesis and Structure of Pristine and Cesium Intercalated Single-Walled Carbon Nanotubes, Applied Physics: A67, pgs. 47-52, spring 1998, the entire teachings of which are incorporated herein by reference. The highest alkali metal saturation values for these nanotube materials was reported to be MC₈ (M=K, Rb, Cs). These values do not represent a significant advance over existing commercially popular materials, such as graphite. Recent experimental results have shown that it is possible to charge single wall carbon nanotubes up to Li₁C₃ and higher. Capacities of crude materials have been determined experimentally to exceed 600 mAh/g. These capacities begin to approach that of pure lithium, but avert lithium's safety concerns. In addition, like mesophase carbon microbeads (MCMB), the lithium is intercalated reversibly so that the carbon nanotubes constitute a dramatic improvement over MCMB as an anode material. Clearly, carbon nanotubes offer new prospects for high-energy batteries and can offer new opportunities for completely new battery designs hitherto unattainable with conventional electrode materials.

Lithiated carbon nanotubes (CNT) have been reported in the scientific and patent literature as a means for providing a high energy, non-metallic anode for lithium batteries. In particular, U.S. Pat. Nos. 6,280,697, 6,422,450 and 6,514,395, the entire teachings of which are incorporated herein by reference, describe in detail the processes for preparing laser-generated carbon nanotubes and their lithiation. However, the prior art does not include the concept of using a lithium metal powder/CNT anode and a CNT cathode to form a high-energy battery.

### SUMMARY OF THE INVENTION

The present invention relates to a high-energy lithium battery system. According to some embodiments of the invention, a battery is provided that includes an anode in electrical communication with a cathode, a separator that separates the anode from the cathode, and a means for electrical communication between the anode and the cathode, wherein the cathode and the anode include CNT, and the anode, and optionally the cathode, is lithiated with lithium metal powder.

In some embodiments, the CNT electrodes may be single wall, multiwall, nanohoms, nanobells, peapods, buckyballs and the like, or other colloquial names for nanostructured carbon materials, or any combination thereof.

These and other features of the present invention will become more readily apparent to those skilled in the art upon consideration of the following detailed description and accompanying drawing, which describe both the preferred and alternative embodiments of the present invention.

### BRIEF DESCRIPTION OF THE DRAWING FIGURES

The invention can be more readily ascertained from the following description of the invention when read in conjunction with the accompanying drawings in which:

FIG. 1 is an illustration of an embodiment of the present invention;

FIG. 2 is graph depicting half-cell discharge tests of embodiments of the present invention.

FIG. 3 is a graph of the cycle testing of an embodiment of the invention.

FIG. 4 is a graph depicting cycle testing of an embodiment of the invention.

FIG. 5 is a graph depicting further cycling of the embodiment illustrated in FIG. 4.

FIG. 6 is a graph depicting cycle testing of an embodiment of the invention.

FIG. 7 is a graph depicting further cycle testing of the embodiment illustrated in FIG. 6.

FIG. 8 is a graph comparing an embodiment of the invention with a prior art material.

### DETAILED DESCRIPTION OF THE INVENTION

According to the invention, a battery is provided that includes an anode in electrical communication with a cathode, a separator that separates the anode from the cathode, and a means for electrical communication between the anode and the cathode, wherein the cathode and the anode include CNT, and the anode, and optionally the cathode, is lithiated with lithium metal powder.

It is understood for the purposes of this invention that the term “battery” may mean and include a single electrochemical cell, or unicell, and/or one or more electrochemical cells connected in series and/or in parallel as known by those of skill in the art. Furthermore, the term “battery” includes, but is not limited to, rechargeable batteries and/or secondary batteries and/or electrochemical cells.

A battery according to embodiments of the invention may include a positive electrode (cathode) and a negative electrode (anode), wherein both electrodes include a carbon nanotube (CNT) material capable of absorbing and desorbing lithium in an electrochemical system, and wherein lithium metal powder is dispersed in the CNT of the anode, and optionally the cathode, a separator separating the cathode and the anode, and an electrolyte in communication with the cathode and the anode.

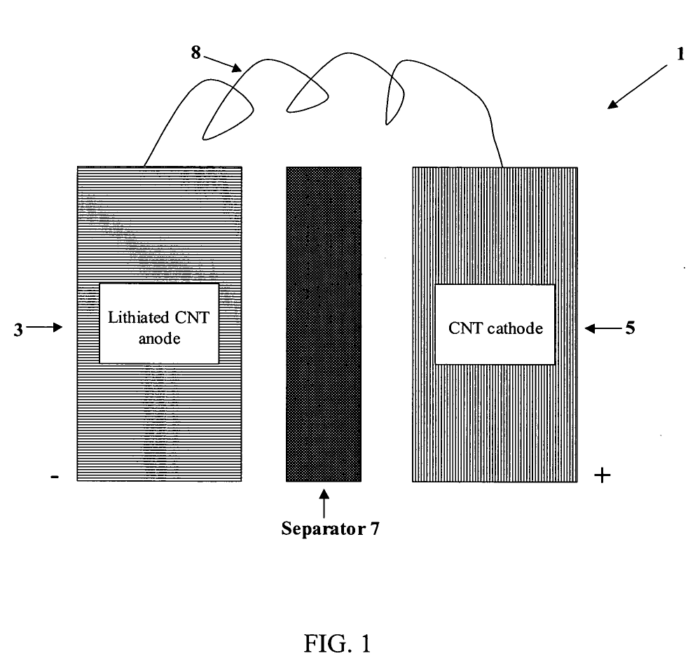

FIG. 1 illustrates an embodiment of the present invention. The battery system 1 depicted includes an anode 3, a cathode 5, a separator 7, and means 8 for facilitating electrical communication between the anode 3 and the cathode 5. In one aspect of this embodiment, the anode 3 and cathode 5 are comprised of various constructions of CNT materials. The CNT material can be multi-walled, single-walled, nanohoms, nanobells, peapods, buckyballs or any other known nanostructured carbon material. The separator 7 comprises an insulating material(s) having a liquid or polymeric cation-conducting electrolyte. The means 8 for electrically communication between the anode 3 and the cathode 5 includes any means well known in the art that facilitates electrical communication between an anode and cathode. Such means include, but are not limited to, a suitably low resistance wire.

As described in detail below, the cathode and anode include CNT, wherein the anode, and optionally the cathode, include lithium metal powder dispersed therein. Throughout this description it should be understood that the general term CNT refers to the whole series of carbon nanotubular materials well known to those skilled in the art. In some embodiments, the CNT electrodes may be single wall, multiwall, nanohoms, nanobells, peapods, buckyballs and the like, or other colloquial names for nanostructured carbon materials, or any combination thereof. The anode and cathode may be formed from the same type of CNT, or they may be formed from different types of CNT. For example, in one embodiment, the cathode may be a single walled nanotube (SWNT), while the cathode is a multi-walled nanotube (MWNT). Further, the CNT may be formed and processed by a variety of methods. For example, CNT may be generated by laser, arc, or other methods known in the art. The CNT may also be treated by a variety of methods known to one of skill in the art, including treatment with carbon dioxide, nitrous oxide, and the like; halogenation, including fluorination and chlorination; and treatment with an organic conducting material. The CNT may also be incorporated in place of carbon black with the metal oxide materials currently used as active materials in Li-ion batteries. These treatment processes will be described further below, and additional information regarding CNT useful in the present invention may be found in U.S. Application No. 2004/234844A1, the disclosure of which is incorporated by reference in its entirety. Details regarding the use of lithium metal powder (LMP) in the anodes, and optionally cathodes, will be described below, but further information is disclosed in U.S. Pub. No. 2005/0131143 to Gao et al., the disclosure of which is incorporated by reference in its entirety.

The cathodes of the present invention include CNT, but may have a variety of constructions. The cathodes may be lithiated or non-lithiated, and the lithiation may be performed by any method known to one of skill in the art, including the use of LMP. For example, in one embodiment, a cathode is formed from SWNT that are electrochemically lithiated using a pure lithium counter electrode and an appropriate electrolyte and separator. In one embodiment, the material is lithiated at a low rate (<100 microA/cm²) for long periods of time (˜20 hrs/0.5 mg of material). This arrangement results in a cell voltage of ˜3.0V before charge and ˜3.2V for the fully charged cell.

In another embodiment, the cathode includes CNT that are chemically modified by fluorination, or other oxidation processes such as chlorination.

In another embodiment, the cathode includes CNT treated with an organic conducting material, for example, a conducting polymer, such as poly (3-octylthiophene). Other conducting polymers that may also be used for this purpose include: substituted polythiophenes, substituted polypyrroles, substituted polyphenylenevinylenes, and substituted polyanilines. Ion doping of these materials or self-doping, by including a sulfonic acid group at the end of the alkyl chain, may render the conducting polymer p-type.

In another embodiment, the cathode incorporates lithiated CNT in place of carbon black with the metal oxide materials currently used as the active cathode material in Li-ion batteries. This may provide a two-fold advantage: 1) the nanotubes may offer higher electronic conductivity to the resulting composite electrode thereby improving cathode performance and 2) the lithiated nanotubes may improve the capacity of the cathode. The high cell voltage may be preserved by the presence of lithium metal oxides in the cathode.

In another embodiment, the cathode is a CNT lithiated with an LMP, which may be lithiated in any manner, including the methods described below with reference to the CNT anode materials. In some embodiments, the cathode and the anode include the same CNT/LMP material.

With respect to the anode, the anode may be formed of CNT capable of absorbing and desorbing lithium in an electrochemical system, wherein LMP is dispersed in the CNT. The lithium metal is preferably provided in the anode as a finely divided lithium powder. More often, the lithium metal has a mean particle size of less than about 60 microns, and more often less than about 30 microns, although larger particle sizes may also be used. The lithium metal may be provided as a so-called “stabilized lithium metal powder”, namely, it has a low pyrophorosity powder, by treating the lithium metal powder with CO₂ and is stable enough to be handled easily.

The CNT anode is capable of reversibly lithiating and delithiating at an electrochemical potential relative to lithium metal of from greater than 0.0 V to less than or equal to 1.5 V. If the electrochemical potential is 0.0 V or less versus lithium, then the lithium metal will not reenter the anode during charging. Alternatively, if the electrochemical potential is greater than 1.5 V versus lithium then the battery voltage will be undesirably low. Preferably, the amount of lithium metal present in the anode is no more than the maximum amount sufficient to intercalate in, alloy with, or be absorbed by the carbon nanotubular material in the anode when the battery is recharged.

In accordance with some embodiments of the invention, the anode can be prepared by providing CNT that are capable of absorbing and desorbing lithium in an electrochemical system, dispersing LMP into the CNT, and forming the CNT and the lithium metal dispersed therein into an anode. Preferably, the LMP and the CNT are mixed with a non-aqueous liquid and a binder and formed into a slurry.

Formation of an anode, or other type of electrode, such as a cathode, according to embodiments of the invention, may be achieved by combining the LMP, CNT, optionally a binder polymer, and a solvent to form a slurry. In some embodiments, an anode is formed when the slurry is coated on a current collector, such as a copper foil or mesh, and is allowed to dry. The dried slurry on the current collector, which together forms the electrode, is pressed to complete the formation of the anode. The pressing of the electrode after drying densifies the electrode so that active material can fit in the volume of the anode.

In some embodiments of the present invention, it may be desirable to prelithiate the CNT material. For the purposes of this invention the terms “prelithiate” and/or “prelithiating” when used with reference to CNT refers to the lithiation of the CNT prior to contact of the CNT with an electrolyte. Prelithiation of CNT can reduce irreversible capacity loss in a battery caused by the irreversible reaction between the lithium metal powder particles in an electrode with an electrolyte in parallel with the lithiation of the CNT.

The prelithiation of CNT according to some embodiments of the invention preferably occurs by contacting the CNT with the LMP. For instance, the CNT can be contacted with a dry LMP or LMP suspended in a fluid or solution. Contact between the LMP and the CNT may lithiate the CNT, thereby prelithiating the CNT.

In some embodiments, CNT and a dry lithium metal powder are mixed together such that at least a portion of the CNT comes in contact with at least a portion of the lithium metal powder. Vigorous stirring or other agitation can be used to promote contact between the CNT and the lithium metal powder. Contact between the lithium metal powder and CNT results in the partial lithiation of the host material, creating prelithiated CNT.

The prelithiation of the CNT may be performed at room temperature. In various embodiments of the present invention, however, the prelithiation of the CNT is performed at temperatures above about 40° C. Prelithiation performed at temperatures above room temperature or above about 40° C. increases the interaction and/or diffusion between LMP and CNT, increasing the amount of CNT that can be lithiated in a given time period.

When exposed to temperatures above room temperature lithium metal powder becomes softer and/or more malleable. When mixed with another substance, the softer lithium metal powder makes more contact with a substance mixed with it. For instance, the interaction and/or diffusion between a mixture of lithium metal powder and CNT that is being agitated is less at room temperature than if the temperature of the mixture is raised above room temperature. Increasing the contact between a lithium metal powder and a reactive species, such as a CNT, increases the amount of lithiation of the reactive species. Therefore, by raising the temperature of a mixture of lithium metal powder and the CNT, the interaction and/or diffusion between the two substances increases, which also increases the lithiation of the host material.

The temperature of the mixture is preferably maintained at or below the melting point of lithium. For instance, the temperature of a mixture of lithium metal powder and CNT can be raised to about 180° C. or less to promote lithiation of the CNT. More preferably, the temperature of a mixture of lithium metal powder and CNT can be raised to between about 40° C. and about 150° C. to promote the lithiation of the CNT.

In other embodiments, CNT are introduced into a solution containing lithium metal powder. The solution can include, for example, mineral oil and/or other solvents or liquids that are preferably inert or non-reactive with lithium metal powder in the solution. When mixed with the solution, the solution is preferably agitated in a manner to promote contact between the CNT and the lithium metal powder. Contact between the CNT and lithium metal powder promotes the lithiation of the CNT, resulting in a prelithiated CNT that can be used to form an anode.

Lithium metal used with various embodiments of the present invention may be provided as a stabilized lithium powder (SLMP). The lithium powder can be treated or otherwise conditioned for stability during transportation. For instance, SLMP can be formed in the presence of carbon dioxide as conventionally known. The dry lithium powder can be used with the various embodiments of the present invention. Alternatively, SLMP can be formed in a suspension, such as in a suspension of mineral oil solution or other solvents. Formation of lithium powder in a solvent suspension can facilitate the production of smaller lithium metal particles. In some embodiments of the present invention, SLMP may be formed in a solvent that can be used with various embodiments of the present invention. The SLMP in the solvent can be transported in the solvent. Further, the SLMP and solvent mixture can be used with embodiments of the present invention, which may remove a mixing step from an electrode production process because the solvent and SLMP are available as a single component. This may decrease production costs and allow the use of smaller or finer lithium metal powder particles with the embodiments of the present invention.

Solvents used with embodiments of the invention should also be non-reactive with the lithium metal, the binder polymers, and the CNT at the temperatures used in the anode or cathode production process. Preferably, a solvent or co-solvent possesses sufficient volatility to readily evaporate from a slurry to promote the drying of a slurry applied to a current collector. For example, solvents can include acyclic hydrocarbons, cyclic hydrocarbons, aromatic hydrocarbons, symmetrical ethers, unsymmetrical ethers, and cyclic ethers.

Various binder polymer and solvent combinations were tested with the embodiments of the present invention to determine binder polymer-solvent pairs that are compatible and stable. Further, anodes formed from the binder polymer-solvent pairs were tested to ensure compatibility. Preferred binder polymer-solvent pairs for use with the production of anodes and cathodes according to some embodiments of the invention are listed in Table I.

TABLE I

| Binder Polymer | Suitable Solvents |
|---|---|
| ethylene propylene | acyclic and cyclic hydrocarbons, |
| diene terpolymer or | including n-hexane, n-heptane, |
| ethylene propylene | cyclohexane, and the like; aromatic |
| diene monomer | hydrocarbons such as toluene, xylene, |
| | isopropylbenzene (cumene), and the like |
| polyvinylidene fluoride | symmetrical, unsymmetrical, and cyclic |
| | ethers, including di-n-butyl ether, methyl |
| | t-butyl ether, tetrahydrofuran, and the like |
| ethylene vinyl acetate | aromatic hydrocarbons such as toluene, |
| | xylene, isopropylbenzene (cumene), and |
| | the like |
| styrene-butadiene rubber | aromatic hydrocarbons such as toluene, |
| | xylene, isopropylbenzene (cumene), and |
| | the like; symmetrical, unsymmetrical, and |
| | cyclic ethers, including di-n-butyl ether, |
| | methyl t-butyl ether, tetrahydrofuran, and |
| | the like |

It is understood that additional binder polymer-solvent pairs can also be used or combined to form slurries and anodes in accordance with the embodiments of the invention.

The separator and electrolyte can be chosen from the many well known in the art. In the present invention, the liquid/solid polymer electrolytes impart added safety to this high energy system.

Research efforts have identified polyphosphates and polyphosphonates (PEP) as good candidates for preparation of polymer electrolytes. In addition, success with both liquid and solid-state electrolyte systems has been realized. These novel materials are relatively inexpensive to prepare in a one step process and have yielded very good lithium ion transport properties of 0.5 as compared to 0.3 for polyethyleneoxide (PEO). Thermal stability testing has also yielded promising results (thermally stable to >300° C.). To extend the operational temperature range from −20 to +90° C., the polyphosphate liquid electrolytes may be blended with propylene carbonate (PC) to enhance the low temperature performance of the polyphosphate materials. These liquids are completely miscible with polar liquids such as PC.

Synthesis of the PEPs is a straightforward, one-step process that minimizes product costs. Following synthesis of the polymers, a liquid polymer electrolyte (LPE) is prepared by dissolving a lithium salt at IM concentration into the fluid polymer. The use of lithium bis-trifluormethanesulfonimide (Lilim, 3M Co.) as the lithium salt in these electrolytes has been quite successful.

The following examples are merely illustrative of the invention, and are not limiting thereon.

### EXAMPLES

Control A:

First, a control sample, which did not contain CNT, was synthesized. 9.65 g of mesophase carbon microbeads (MCMB) acquired from Osaka Gas Ltd. was mixed with 0.35 g of PEO powder (Aldrich, 5×10⁶ MW). Next, 26.25 g of anhydrous p-xylene (Aldrich) was combined with 0.975 g of Lectro® Max stabilized lithium metal powder (SLMP). This was mixed with an overhead mixer at ˜300 rpm for 5 min. The MCMB/PEO mixture was then sequentially combined with the SLMP in xylene. The resulting mixture was covered with tin foil to prevent solvent loss, heated to about 55° C., and stirred at about 300 rpm for 3 hr. The result was a uniform black slurry which was coated onto a piece of copper foil that had been lightly sanded, degreased with acetone, and dried in the over prior to use. This was allowed to dry on the hot plate in the glove box overnight. A small square of this material was cut out, pressed, and stored in an argon filled ziplock freezer bag when out of the glove box, to prepare it for testing.

Control B:

The second control synthesized was a slurry formed from non-pretreated CNT. The procedure used was analogous to that of Control A, but was scaled down to accommodate the smaller quantity of CNT. A quantity of as-received Hipco SWNT material was dried under Ar overnight before use. As with Control A, this and all other sample preparations were executed in a glovebox. The Control A preparation method was followed, except that the PEO was omitted. As before, 0.02 g of SLMP was combined with 10 ml of xylene and mixed thoroughly. The Hipco SWNT (0.10 g) were then added to the xylene mixture and stirred on the hotplate at about 55° C. for 3 hr. The resulting mixture was a uniform, black, thin, paste-like material that was spread onto a large aluminum pan to dry overnight. Once dry, the material was scraped off the pan, as it did not adhere well, and placed in a vial.

Sample Material 1

This first sample material incorporated laser-produced SWNT soot that had been burned in N₂O for 20 minutes at 600° C. and then treated with CO₂ at 750° C. for 1 hour. The procedure for combining the CNT with SLMP was identical to that for Control B, except that 17 mg of the SWNTs were combined with 13 mg of SLMP and sufficient xylene to form a fluid mixture. No binder was employed. Following complete mixing, the material was dried on a hotplate in the glovebox at 55° C. The sample was collected and stored in a vial until used.

Sample Material 2

The second sample material incorporated CO₂-treated Hipco nanotubes (10 L/min of CO₂ at 750° C. for 1 hr). The preparation method was similar to that provided with respect to Sample Material 1, except that 50 mg of Hipco nanotubes and 38.5 mg of SLMP were used. Sufficient xylene was added to provide a fluid mixture.

Sample Material 3

The third sample material incorporated Arc-generated SWNTs, which were treated with N₂O at 2 L/min for 5 min at 600° C. The preparation was similar to that provided with respect to Sample Material 1, but 22 mg of the SWNTs and 10 mg of SLMP were combined with 15 ml of anhydrous xylene. The mixture was sonicated for 1 hr, stirred, and sonicated again for 1 hr. The resulting mixture was a homogenous ink-like suspension. This product was filtered in the glove box to produce a nanotube paper.

Electrochemical Results:

Half-Cell Tests

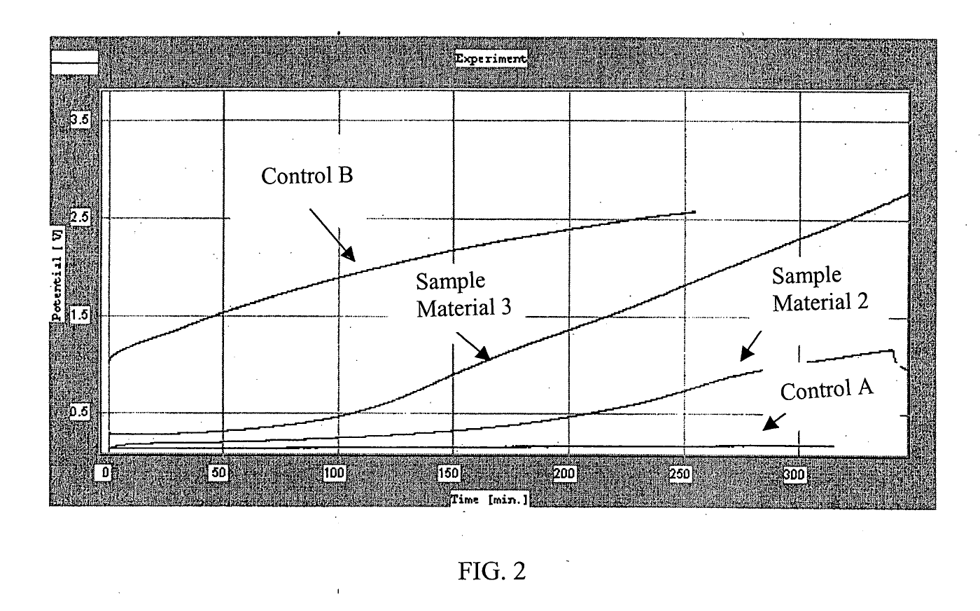

To ascertain the relative quality of the lithiation of some of the prepared materials, the various products were discharged against a lithium foil counter electrode in the standard lab cell. Generally speaking, the tests were qualitative in nature, in that the quantities of the materials tested were not measured. A small square of each material was cut out and pressed in a stainless steel pellet press using a hydraulic jack (the pellet press was kept in an argon filled ziplock bag when not in the glove box) to prepare it for testing. The discharge curves for several materials are compared in FIG. 2.

As can be seen from FIG. 2, the Open Circuit Voltage (OCV) of Control A was quite low (120 mV vs Li/Li⁺) indicating that the material was highly lithiated. Upon application of 100 μA of discharge current, the cell voltage gradually increased, indicating removal of lithium from the MCMB electrode.

The discharge curve for Control B is also shown in FIG. 2. Control B appeared to be less lithiated than Control A, as indicated by the relatively high OCV (˜1.0V vs Li/Li⁺) and the higher polarization of the cell voltage as the discharge current is applied. Even so, at least four hours of discharge was needed for the Control B electrode to reach 2.5V.

Sample Materials 2 and 3 were next tested. As can be seen in the FIG. 2, Sample Material 2 appears to be the more highly lithiated of the two samples, as indicated by the comparatively low OCV and the slow polarization upon discharge.

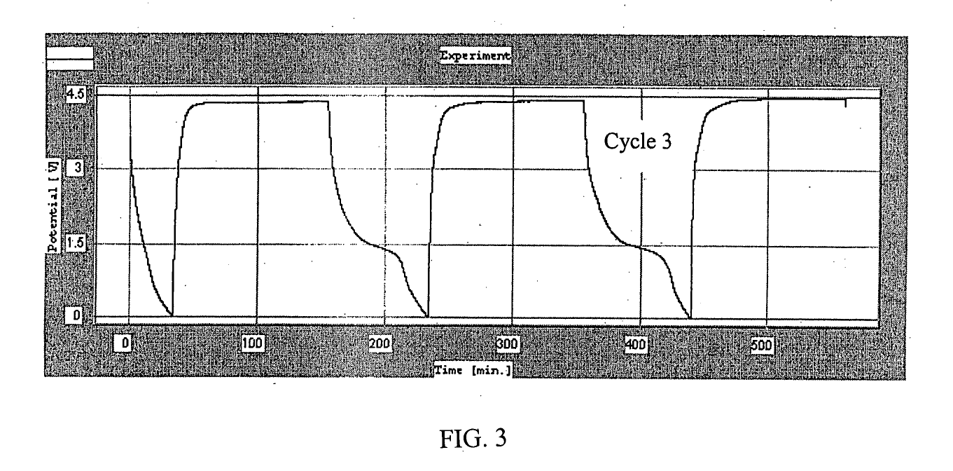

Following the half-cell tests, a series of experiments were performed using different combinations of electrode materials in full cell tests. The first test sought to determine if the SLMP CNT electrode material could be used as a replacement for the electrochemically-lithiated anodes that have previously been used in CNT/CNT cells. To this end, Sample Material A was used to form the anode, a non-lithiated CO₂-treated laser produced SWNT buckypaper was used to form the cathode, and the cell was cycled several times as shown in FIG. 3.

In this test, the charging was performed at a much higher rate than the discharging in order to drive the lithium back into the anode (charged at 500 μA, discharged at 100 μA; 53 Wh/kg). As can be seen, the typical voltage plateau appears at around 1.5V.

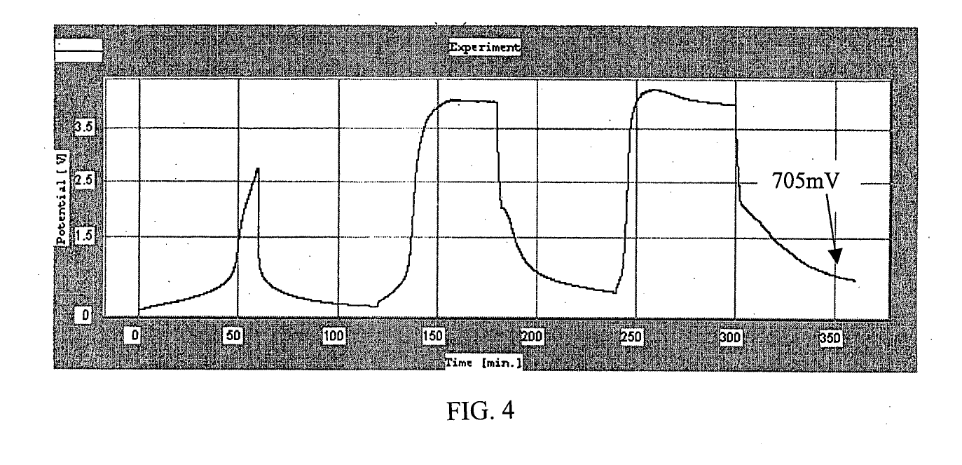

Next, the cycling of two electrodes formed from the same material was performed in an attempt to drive all of the stabilized lithium metal powder from one electrode into the other, thereby developing a cell voltage and improving the lithiation of the two materials. The concept was first tested with Control A, as seen in FIG. 4. The initial cycles were run at high charge rate and low discharge rate in order to move the lithium from one electrode to the other (charged at 500 μA, discharged at 100 μA). The total weight of material in the cell (both electrodes) was 38 mg. As can be seen in FIG. 4, with successive charging, the discharge capacity of the cell improves. By the third cycle, the cell exhibits 705 mV after discharging for one hour at 100 microamps. These results indicate that this cell is a rudimentary Li-ion battery.

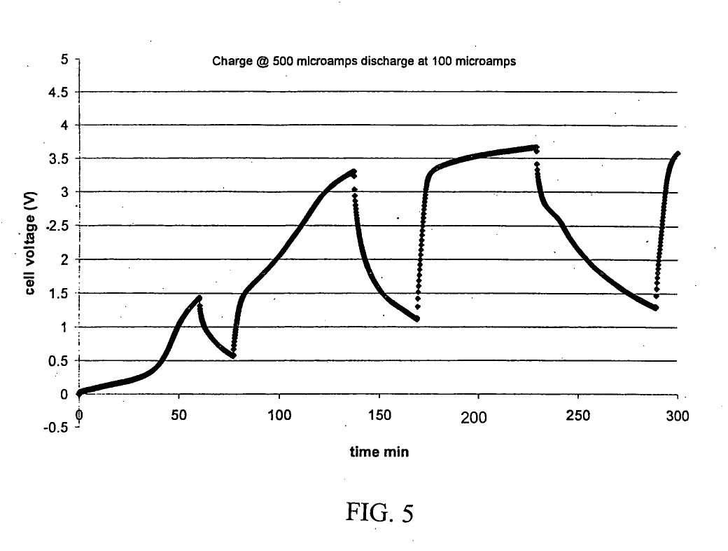

Further recycling of the Control A cell resulted in what appeared to be cell shorting and cell failure as evidenced by the results shown in FIG. 5. Attempts to remedy this problem by inserting additional separators proved fruitless, i.e., the cell shorted once again.

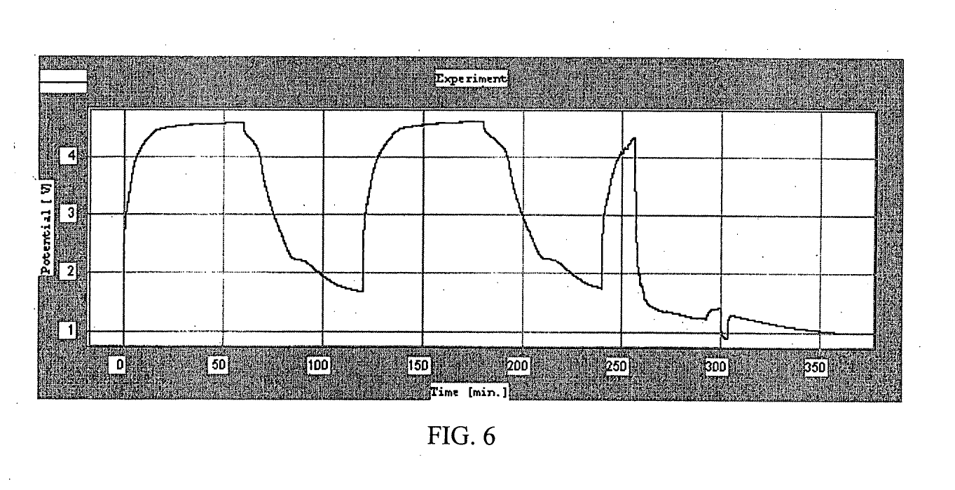

A second test cell was then prepared, wherein both the anode and the cathode were formed from Sample Material 2. The total weight of the electrodes in this cell was 8 mg. The cycling results for this cell are shown in FIG. 6. The cycle criterion was the same as Control A (charged at 500 μA, discharged at 100 μA), but following the same number of initial cycles, the cell exhibited a higher voltage on the third discharge (1310 mV) than the Control A cell. Since there was 5 times more material in the MCMB Control A cell than in the CNT Sample Material 2 test cell, it appears that the Sample Material 2 test cell was far more efficient than Control A cell.

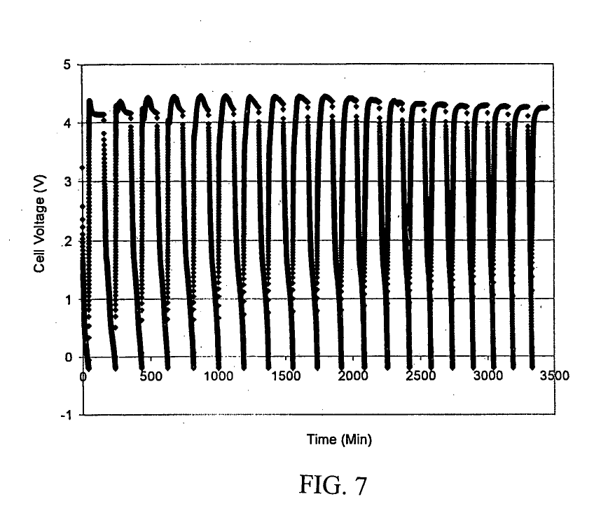

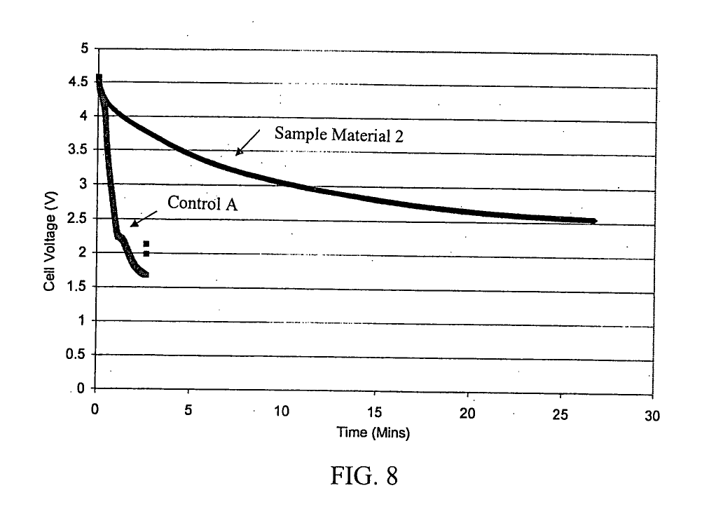

Further, the problem of shorting and cell failure appeared to be far less of a problem with the Sample Material 2 test cell, which ran for more than twenty cycles as shown in FIG. 7 (charged and discharged at 200 μA). Further evidence of the greater efficiency of the Sample Material 2 test cell vs. the Control A cell is shown in FIG. 8, in which the capacity of each cell on the seventh cycle for a one-hour discharge is compared. As can be seen in FIG. 8, although neither cell was discharged for a long period, the capacity of the CNT cell is far greater than that of the MCMB cell.

Having thus described certain embodiments of the present invention, it is to be understood that the invention defined by the appended claims is not to be limited by particular details set forth in the above description as many apparent variations thereof are possible without departing from the spirit or scope thereof as hereinafter claimed.

What is claimed is:

1. A battery, comprising an anode in electrical communication with a cathode, a separator that separates said anode and said cathode, a means for electrical communication between said anode and said cathode, wherein said anode and said cathode is a carbon nanotube and said anode is a carbon nanotube lithiated with lithium metal powder.

2. The battery of claim 1, wherein said carbon nanotube is selected from the group consisting of multi-walled nanotubes, single-walled nanotubes, nanohorns, nanobells, peapods, buckyballs and a combination thereof.

3. The battery of claim 2, wherein said carbon nanotube comprises single-walled nanotubes.

4. The battery of claim 1, wherein said separator comprises a lithium salt electrolyte.

5. The battery of claim 4, wherein said electrolyte is a phosphate or a polyphosphate electrolyte.

6. The battery of claim 1, wherein said carbon nanotube has a reversible capacity in excess of 600 mAh/g.

7. The battery of claim 1, wherein said carbon nanotube alkali saturation is MC₈, wherein M is selected from the group consisting of K, Rb, and Cs.

8. The battery of claim 1, wherein said cathode is comprised of single-walled nanotubes, and wherein said anode is comprised of multi-walled nanotubes.
